(19) United States
(12) Patent Application Publication
(10) Pub. No.: US 2021/0062863 A1
(43) Pub. Date: Mar. 4, 2021

(54) Rod Bearing of Sliding Door

(71) Applicants: Hyundai Motor Company, Seoul (KR); Kia Motors Corporation, Seoul (KR)

(72) Inventor: Kichang Kim, Suwon-si (KR)

(21) Appl. No.: 16/742,289

(22) Filed: Jan. 14, 2020

(30) Foreign Application Priority Data
Aug. 28, 2019 (KR) 10-2019-0105951

(51) Int. Cl. F16C 29/04; E05D 15/06; E05F 5/00; B60J 5/06

(52) U.S. Cl. CPC F16C 29/04; E05D 15/0621; E05Y 2900/531; B60J 5/06; E05F 5/003

(57) ABSTRACT

A rod bearing is mounted to a roller sliding along a rail to drive a sliding door of a vehicle body. The rod bearing includes an outer side portion formed in a ring shape and made of the same metallic material as the rail and an inner side portion made of a plastic material. The rod bearing has a hybrid type composite structure in which a material of the outer side portion and a material of the inner side portion are different from each other.

### CROSS-REFERENCE TO RELATED APPLICATIONS

This application claims priority to Korean Patent Application No. 10-2019-0105951, filed in the Korean Intellectual Property Office on Aug. 28, 2019, which application is hereby incorporated herein by reference.

### TECHNICAL FIELD

The disclosure relates to a rod bearing of a sliding door.

### BACKGROUND

FIG. 1 is a perspective view of a van in a state in which a sliding door of a side thereof is closed, and FIG. 2 is a perspective view for explaining a behavior in a mounted state of a driving device for driving the sliding door in FIG. 1.

As shown in FIG. 1, in general, a van is provided with a sliding door 30 capable of being opened and closed in a sliding manner on one side of a vehicle body so that a passenger may get on and off. Recently, a sliding door of a type that is automatically opened and closed by a switch operation has been applied as the sliding door 30, and as shown in FIG. 2, a driving device 10 (see FIG. 3) is mounted on the sliding door 30 to automatically open and close the sliding door 30.

However, when a sliding door of a conventional van is operated in order for a passenger to ride in the van, abnormal noise may occur at a portion (A in FIG. 1) in which the driving device 10 is installed.

FIG. 3 is a perspective view illustrating the driving device in FIG. 2, and FIG. 4 is a schematic view illustrating a state in which a roller travels along a corner portion of a rail in the driving device in FIG. 3.

Referring to FIG. 3, the driving device 10 includes a rail 1 provided in the vehicle body and a roller 2 sliding along the rail 1. The roller 2 is provided with a guide bearing 3 for guiding an opening direction and a rod bearing 4 for rolling motion along the rail 1.

That is, two of the guide bearings 3 are coupled to an upper end of the roller 2, one of the rod bearing 4 is coupled to a lower end of the roller 2, and a coupling hole for coupling a door cable is formed at one side of the roller 2.

In this case, as shown in FIG. 4, when the rod bearing 4 enters a corner portion 5 of the rail 1 by the operation of the sliding door 30, a step occurs at the corner portion 5 on a path along which the rod bearing 4 and the guide bearings 3 move in a parallel direction, and as a result, a slip occurs at a lower end portion of the rod bearing 4.

Because in the driving device 10 the rod bearing 4 is made of a plastic material while the rail 1 is made of stainless steel (SUS), friction noise may occur at a portion where the rod bearing 4 is in contact with the rail 1 by the strain difference between the rod bearing 4 and the rail 1 having different materials from each other.

Korean Patent Unexamined Publication Nos. 2002-0043885 and 2005-0042854 are reference literatures for the above content.

### SUMMARY

The disclosure relates to a rod bearing of a sliding door. Particularly embodiments relate to a rod bearing of a sliding door for reducing operating noise, which may prevent the generation of friction noise due to slip with a rail when the sliding door is operated.

It is an aspect of the disclosure to provide a rod bearing of a sliding door capable of reducing operating noise in which an outer side thereof is made of stainless steel that is the same material as a rail such that friction noise caused by differences in strain rate between different materials due to the rail of a different material may be prevented and in which an inner side thereof is made of a soft plastic material such that vibration isolation may be improved.

Additional aspects of the disclosure will be set forth in part in the description which follows and, in part, will be obvious from the description, or may be learned by practice of the disclosure.

In accordance with an aspect of the disclosure, a rod bearing, which is mounted to a roller sliding along a rail to drive a sliding door of a vehicle body, includes an outer side portion formed in a ring shape and made of the same metallic material as the rail to prevent slip of the rod bearing, and an inner side portion made of a plastic material to enable vibration isolation by buffering when the sliding door is operated.

The rod bearing may have a hybrid type composite structure in which the material of an outer side and the material of an inner side are different from each other.

The outer side portion may be made of stainless steel (SUS) to prevent abnormal noise caused by slip.

A surface of the stainless steel may be coated with fluorine.

The inner side portion may include a material having flexibility to absorb shock generated when the sliding door is operated.

The inner side portion may include rubber.

A curved groove may be formed along a circumference at an outer center portion of the inner side portion, and the outer side portion may have a shape corresponding to the curved groove to be inserted into and coupled to the curved groove.

The curved groove may be formed to be tapered such that a width thereof becomes wider toward the outside.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view of a van in a state in which a sliding door of a side thereof is closed;

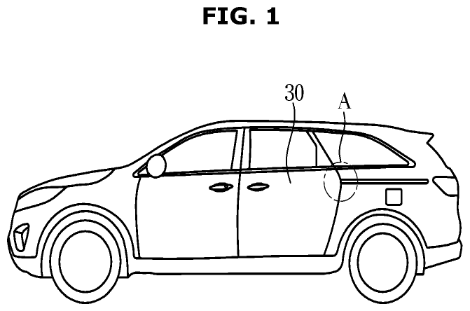

FIG. 2 is a perspective view for explaining a behavior in a mounted state of a driving device for driving the sliding door in FIG. 1;

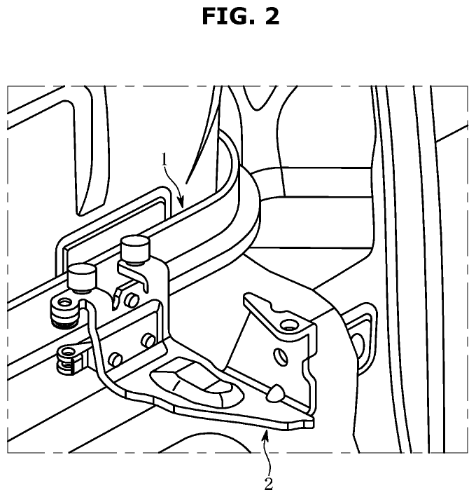

FIG. 3 is a perspective view illustrating the driving device in FIG. 2;

FIG. 4 is a schematic view illustrating a state in which a roller travels along a corner portion of a rail in the driving device in FIG. 3;

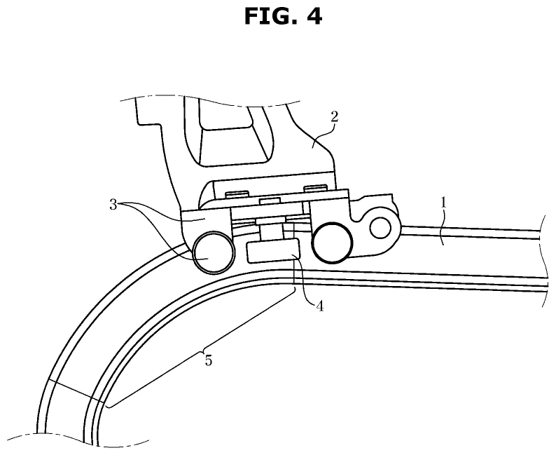

FIG. 5 is a perspective view illustrating a rod bearing of a sliding door for reducing operating noise according to an embodiment of the present disclosure;

FIG. 6 is an exploded perspective view illustrating the rod bearing of the sliding door for reducing operating noise in FIG. 5;

FIG. 7 is a schematic view illustrating a state in which the rod bearing of the sliding door for reducing operating noise in FIG. 5 is mounted to the roller;

FIG. 8 is an exploded perspective view illustrating a rod bearing of a sliding door for reducing operating noise according to another embodiment of the present disclosure; and

FIG. 9 is a schematic view illustrating a state in which the rod bearing of the sliding door for reducing operating noise in FIG. 8 is mounted to a roller.

### DETAILED DESCRIPTION OF ILLUSTRATIVE EMBODIMENTS

The embodiments described herein and the configurations shown in the drawings are only examples of embodiments of the disclosure, and various modifications may be made at the time of filing of the disclosure to replace the embodiments and drawings of the present specification.

Like reference numbers or signs in the various drawings of the application represent parts and components that perform substantially the same functions.

The terms used herein are for the purpose of describing the embodiments and are not intended to restrict and/or to limit the disclosure. For example, the singular expressions herein may include plural expressions, unless the context clearly dictates otherwise. Also, the terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms. These terms are only used to distinguish one component from another. For example, without departing from the scope of the disclosure, the first component may be referred to as a second component, and similarly, the second component may also be referred to as a first component. The term “and/or” includes any combination of a plurality of related items or any one of a plurality of related items.

Hereinafter embodiments of the disclosure will be described in detail with reference to the accompanying drawings.

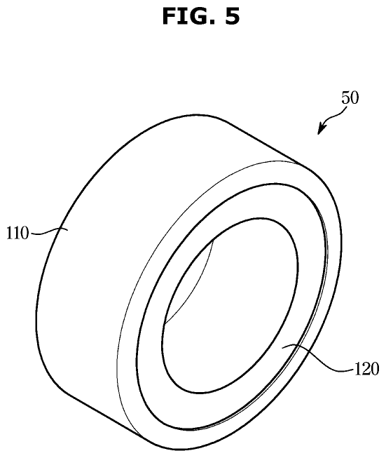

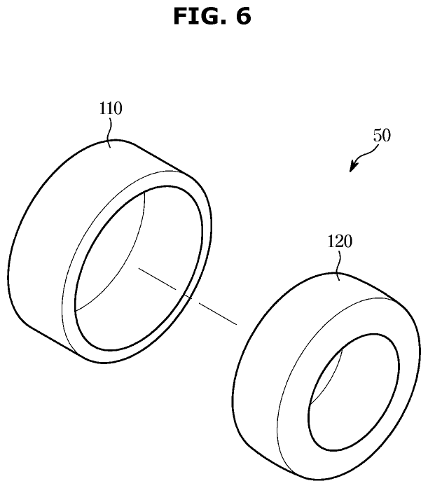

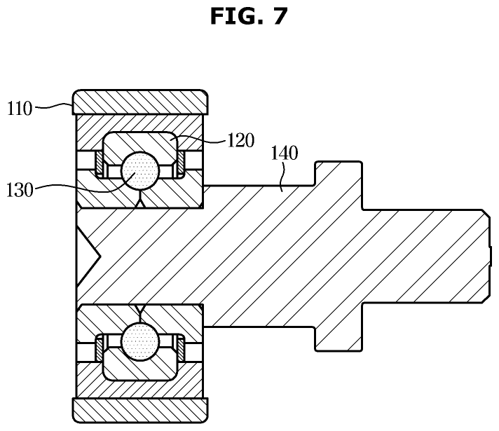

FIG. 5 is a perspective view illustrating a rod bearing of a sliding door for reducing operating noise according to an embodiment of the present disclosure, FIG. 6 is an exploded perspective view illustrating the rod bearing of the sliding door for reducing operating noise in FIG. 5, and FIG. 7 is a schematic view illustrating a state in which the rod bearing of the sliding door for reducing operating noise in FIG. 5 is mounted to the roller.

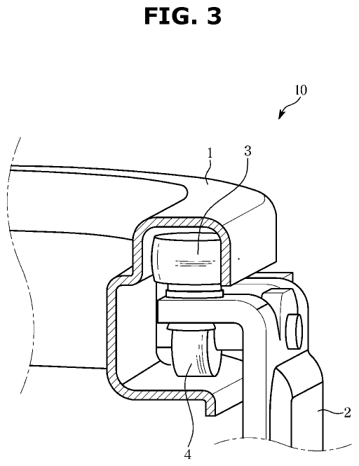

A rod bearing 50 of a sliding door for reducing operating noise according to an embodiment of the present disclosure is for driving the sliding door of a vehicle body and is mounted to a roller 2 (see FIG. 7) sliding along the rail 1 (see FIG. 3).

Generally, the driving method of the sliding door includes a manual method of pulling the sliding door by hand and an automatic method of pulling a door cable of a button operation with a predetermined force. Under normal conditions, abnormal noise is not observed when the sliding door is operated, but abnormal noise may be generated when the door cable is operated with an excessive force or rust occurs due to the inflow of foreign substances at a corner portion of the rail 1. The present disclosure has been designed for robust design guides that may reduce the likelihood of operating noise in sliding doors, even in the environmental conditions such as summer or long time use. Through noise generating mechanism analysis, the effect was verified to improve the friction noise caused by slip in the dissimilar material matching portions.

Referring to FIGS. 5 and 6, the rod bearing 50 of the sliding door for reducing the operating noise of the present disclosure (hereinafter the “rod bearing 50”) has a ring shape as a whole and includes an outer side portion 110 that is formed outside, and an inner side portion 120 that is formed inside the outer side portion 110.

Each of the outer side portion 110 and the inner side portion 120 has a ring shape, and the inner side portion 120 may be inserted into the outer side portion 110, and the outer side portion 110 may be formed to cover the entire outer surface of the inner side portion 120.

In a case where the sliding door is operated manually or automatically, the rod bearing 50 slides along the rail 1. In this case, because the outer side portion 110 and the rail 1 are formed of the same material, friction noise may be prevented from occurring at a contact portion between the outer side portion 110 and the rail 1 due to the difference in strain rate between different materials. That is, the possibility of occurrence of friction noise due to different materials may be reduced in a matching portion that is the contact portion between the rod bearing 50 and the rail 1.

In addition, because the outer side portion 110 is made of stainless steel, wear may be prevented from occurring on a surface thereof due to the material properties of the stainless steel. Further, by fluorine-coating the surface of the outer side portion 110, that is, the surface of the stainless steel, rust may be prevented from occurring on the surface of the outer side portion 110, and the occurrence of abnormal noise on the surface of the rod bearing 50 due to uneven wear or rust may be prevented.

The inner side portion 120 may include a soft plastic material having flexibility, for example, rubber having flexibility. Accordingly, as the vibration isolation of the rod bearing 50 is improved, the rod bearing 50 may suppress the external vibration transmitted from the vehicle body and may slide more stably along the rail 1.

As such, the inner side portion 120 is made of a different material from the outer side portion 110, so that the rod bearing 50 may have a hybrid type composite structure in which the outer and inner materials are different from each other.

In other words, the rod bearing 50 constitutes a composite structure of dissimilar materials which includes the outer side portion 110 having stainless steel and the inner side portion 120 having a flexible material, that is, a hybrid rod bearing composite structure made of a hard material for preventing slip of the outside and a soft material for vibration isolation of the inside.

Accordingly, when the rod bearing 50 slides along the rail 1, the possibility of occurrence of irregular abnormal vibration and abnormal noise due to uneven wear of the outer side portion 110 may be reduced, and the inner side portion 120 may suppress vibration generated during driving through flexibility by being be made of a plastic material.

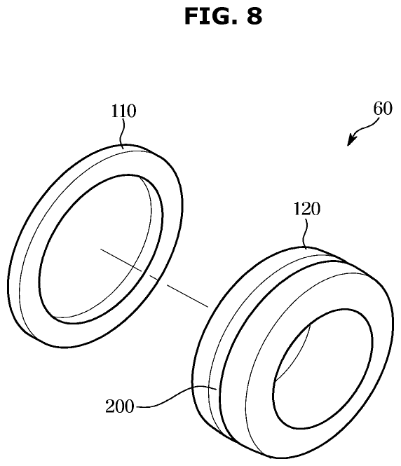

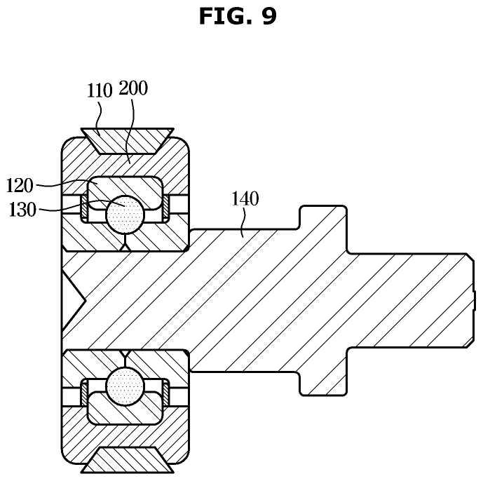

FIG. 8 is an exploded perspective view illustrating a rod bearing of a sliding door for reducing operating noise according to another embodiment of the present disclosure, and FIG. 9 is a schematic view illustrating a state in which the rod bearing of the sliding door for reducing operating noise in FIG. 8 is mounted to a roller.

A rod bearing 60 according to the present embodiment is the same as the rod bearing 50 described with reference to FIGS. 5 to 7 except that a curved groove 200 is formed on an outer surface of the inner side portion 120, and thus duplicate descriptions will be omitted and the same reference numerals will be used for the same components.

Referring to FIGS. 8 and 9, in the rod bearing 60 according to the present embodiment, the curved groove 200 is formed along a circumference of the inner side portion 120 on the outer surface of the inner side portion 120.

As shown in FIG. 8, the curved groove 200 may be formed at the center of the outer surface of the inner side portion 120 and may extend along the circumference of the inner side portion 120 to have a predetermined width.

The outer side portion 110 has one side formed in a shape corresponding to the curved groove 200 to be inserted into the curved groove 200 and forms a rod bearing together with the inner side portion 120. That is, the outer side portion 110 may be formed to be inserted into the inner side portion 120 in a manner of being easily coupled to and separated from the inner side portion 120.

The outer side portion 110 protrudes outward in a state of being inserted into the curved groove 200 to completely cover the inner side portion 120 and at the same time to come into contact with the surface of the rail 1 when the rod bearing 60 slides along the rail 1. Accordingly, as described above, when the rod bearing 60 is operated, the outer side portion 110 made of the same material as the rail 1 comes into contact with the rail 1, thereby preventing the occurrence of friction noise.

As shown in FIG. 9, the curved groove 200 may be formed to be tapered such that a width thereof becomes wider from a side adjacent to a center portion of the inner side portion 120 toward the outside.

The outer side portion no may be formed in a shape corresponding to the curved groove 200, that is, in a tapered shape such that a width thereof becomes wider from the center portion of the inner side portion 120 toward a circumferential direction, in order to be inserted into the curved groove 200 and coupled to the inner side portion 120. Accordingly, when the outer side portion 110 is coupled to the inner side portion 120, the outer side portion no may be more stably supported on the inner side portion 120 through the curved groove 200, thereby being stably seated.

Further, the outer side portion no is formed to protrude outwardly in a state of being inserted into the curved groove 200 to cover the outer surface of the inner side portion 120, so that the outer side portion no may come into contact with the surface of the rail 1 when the rod bearing 60 slips.

As is apparent from the above, by a rod bearing of a sliding door for reducing the operating noise of the present disclosure, the operating noise generated at a corner portion of a rail when the sliding door is operated can be effectively reduced.

While the disclosure has been particularly described with reference to exemplary embodiments, it should be understood by those of skilled in the art that various changes in form and details may be made without departing from the spirit and scope of the disclosure.

What is claimed is:

1. A rod bearing to be mounted to a roller sliding along a rail to drive a sliding door of a vehicle body, the rod bearing comprising:
an outer side portion formed in a ring shape and made of the same metallic material as the rail; and
an inner side portion made of a plastic material, wherein the rod bearing has a hybrid type composite structure in which a material of the outer side portion and a material of the inner side portion are different from each other.

2. The rod bearing according to claim 1, wherein the outer side portion is made of stainless steel.

3. The rod bearing according to claim 2, wherein the outer side portion is made of stainless steel to prevent abnormal noise caused by slip.

4. The rod bearing according to claim 2, wherein a surface of the stainless steel is coated with fluorine.

5. The rod bearing according to claim 1, wherein the inner side portion includes a material having flexibility to absorb shock generated when the sliding door is operated.

6. The rod bearing according to claim 5, wherein the inner side portion includes rubber.

7. The rod bearing according to claim 1, wherein the outer side portion is made of the same metallic material as the rail to prevent slip of the rod bearing.

8. The rod bearing according to claim 1, wherein the inner side portion is made of the plastic material to enable vibration isolation by buffering when the sliding door is operated.

9. The rod bearing according to claim 1, wherein
a curved groove is formed along a circumference at an outer center portion of the inner side portion; and
the outer side portion has a shape corresponding to the curved groove to be inserted into and coupled to the curved groove.

10. The rod bearing according to claim 9, wherein the curved groove is formed to be tapered such that a width thereof becomes wider toward the outside.

11. A vehicle comprising:
a vehicle body;
a rail attached to the vehicle body, the rail made of a metallic material;
a sliding door attached to the vehicle body by the rail;
a sliding roller slidably attached to the rail; and
a rod bearing mounted to the sliding roller to drive the sliding door along the rail, the rod bearing comprising an outer side portion formed in a ring shape and made of the same metallic material as the rail and an inner side portion made of a plastic material, wherein the rod bearing has a hybrid type composite structure in which a material of the outer side portion and a material of the inner side portion are different from each other.

12. The vehicle according to claim 11, wherein the outer side portion is made of stainless steel.

13. The vehicle according to claim 12, wherein the outer side portion is made of stainless steel to prevent abnormal noise caused by slip.

14. The vehicle according to claim 12, wherein a surface of the stainless steel is coated with fluorine.

15. The vehicle according to claim 11, wherein the inner side portion includes a material having flexibility to absorb shock generated when the sliding door is operated.

16. The vehicle according to claim 15, wherein the inner side portion includes rubber.

17. The vehicle according to claim 11, wherein the outer side portion is made of the same metallic material as the rail to prevent slip of the rod bearing and the inner side portion is made of the plastic material to enable vibration isolation by buffering when the sliding door is operated.

18. The vehicle according to claim 11, wherein
a curved groove is formed along a circumference at an outer center portion of the inner side portion; and
the outer side portion has a shape corresponding to the curved groove to be inserted into and coupled to the curved groove.

19. The vehicle according to claim 18, wherein the curved groove is formed to be tapered such that a width thereof becomes wider toward the outside.
